(19) United States
(12) Patent Application Publication
(10) Pub. No.: US 2008/0231915 A1
(43) Pub. Date: Sep. 25, 2008

(54) SCANNING DEVICE WITH MULTIFOCUS AND MULTIRESOLUTION

(75) Inventor: Ling Ta Su, Hsin-Tien City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Creative Sensor Inc., Hsin-Tien City (TW)

(21) Appl. No.: 12/111,615

(22) Filed: Apr. 29, 2008

Related U.S. Application Data
(62) Division of application No. 10/919,826, filed on Aug. 17, 2004.

(51) Int. Cl. H04N 1/04

(52) U.S. Cl. 358/474

(57) ABSTRACT

A scanning device with multifocus and multiresolution is provided. The scanning device is formed by the combination of the glass plate, the circuit boards, the rod lenses and the light-sensitive sensor arrays. Furthermore, since the relative positions of the circuit boards, the relative positions of the light-sensitive sensor arrays, the thicknesses of the light-sensitive sensors, the vertical distance between the glass plate and the light-sensitive sensor array, the thickness of the glass plate and the length of the glass plate are adjustable, the scanning device has the multifocus and multiresolution functions.

### CROSS REFERENCE TO RELATED APPLICATION

This application is a division of U.S. patent application Ser. No. 10/919,826, filed Aug. 17, 2004, which is incorporated by reference as if fully set forth.

### FIELD OF INVENTION

This invention mainly relates to a scanning device using a contact image sensor (CIS) technology for scanning various objects, such as the reflection copies or the transparency manuscripts, and more particularly to a scanning device with different foci and resolutions.

### BACKGROUND

The working principle of the contact image sensor (CIS) module is that, at first light are illuminated from a light source to the documents to be scanned and then the light reflected from the scanned documents are received by the light-sensitive sensors, such as a charge-coupled device (CCD) or a complementary metal oxide semiconductor (CMOS). Finally, the image information of the scanned document are obtained by the light-sensitive sensors, wherein the reflected lights received by the light-sensitive sensors are converted into the electrical signals and then the analog or the digital pixel data is produced accordingly. During the process of scanning, since the various intensities of light reflected from the different images areas could be detected by the CCD, it is possible to use the principle that the light reflected from the darker areas of the scanned document would have a lower intensity and the light reflected from the brighter areas of the scanned document would have a higher intensity to convert the reflected light to the analog or the digital pixel data, wherein the intensities of electrical signals (the analog or the digital pixel data) are in direct ratio to the intensities of light. Finally, the image or texts processing software that are compatible with the CIS are applied to read the data and then the data would be reconstructed as an image file of the computer.

The image-capture performance of CIS is excellent as result of the mature light controlling technology. Therefore, the image quality obtained by the optical module is not only important but also one of the main reasons affecting the image-capture performance of CIS.

Presently, the mainstream method for reading optical images is the foresaid CIS technology. CIS technology is to combine the light source, the rod lens, the sensor board and the case into a module format.

Please refer to FIG. 1(a), which is a cross-sectional view of a scanning module using CIS technology in the prior art. The scanning module 10 is formed by the combination of the light source 11, the rod lens 12, the spacer 13, the glass plate 14, the circuit board 15 and the light-sensitive sensor 16, wherein the light-sensitive sensor 16 made of the CCD or the CMOS is located on the circuit board 15.

In the scanning process, the glass plate 14 of the scanning module 10 is used as the datum plane. The spacer element 13 is applied to keep the focal length between the rode lens 12 and the object to be scanned (not shown) in a constant value. Further, the light emitted from the light source 11 would be reflected to the rod lens 12 by the scanned object, and then the rod lens 12 focuses the image picture to the light-sensitive sensor 16, which is used for obtaining image signals.

Please refer to FIG. 1(b), which is a cross-sectional view showing the relationship between an object to be scanned and a scanning module using CIS technology in the prior art. As shown in FIG. 1(b), it is easy to keep the focal length in a constant value since the scanned object 17 is flatly located on the glass plate 14. Consequently, the image quality obtained by the conventional scanning module 10 is fine.

However, while scanning a filmstrip or a film, the image quality obtained from the conventional scanning module 10 is not so well. Please refer to FIG. 1(c), which is a cross-sectional view showing another relationship between an object to be scanned and a scanning module using CIS technology in the prior art. As shown in FIG. 1(c), the photo part 181 of the object 18 is kept a little distance from the glass plate 14 as a result of the existence of the outer frame 182 of the object 18. That is to say, the object 18 cannot contact with the glass plate 14 completely. And, the outer frame 182 and the photo part 181 are not in the same scanning plane. At the mean time, since the conventional scanning module 10 cannot satisfy with scanning an object requiring two focal lengths simultaneously, the modulation transfer function (MTF) of the quality of the image-capture is bad. Therefore, the scanning quality of the conventional scanning module 10 for scanning the object requiring different focal lengths is not so good.

Presently, as shown in FIG. 1(c), the most common technology used to overcome the problems derived from scanning an object requiring two focal lengths is to use the height adjustable spacer 13. By lowering or lifting the position of the height adjustable spacer 13, the distance between the photo part 181 and the rod lens 12 is adjusted to the same as that between the outer frame 182 and the rod lens 12. That is to say, the focal lengths of the photo part 181 and the outer frame 182 are adjusted to be the same and the scanning module 10 with one focal length could be used for scanning an object requiring two focal lengths due to the height adjustable spacer 13.

There is still a problem for a scanning module 10 using a height adjustable spacer 13, since the height, adjustable spacer 13 is made of one of a plastic ball, a steal ball, a slide and the combination thereof. The tolerance, the deformation and the abrasion of the height adjustable spacer 13 will make it difficult to control the accuracy of the lifting or the lowering the height of the height adjustable spacer 13.

In addition, while the object to be scanned is the small sized object, such as a filmstrip or a film, the higher resolution is required. Since the resolution of the generally scanning module is not qualified, another scanning module with higher resolution is needed. That is to say, two scanning modules with different resolutions are needed for obtaining good image, quality of scanning various objects. However, the use of two scanning module is not only very inconvenient but also uneconomical.

For overcoming the above-described problems, a CIS scanning device with bi-focus and bi-resolution has been disclosed (JP, 2004-126284, A). Please refer to FIG. 2(a) and FIG. 2(b), the scanning device 20 is formed by the combination of the first light source 211, the second light source 212, the first rod lens 22, the second rod lens 23, the glass plate 24, the circuit board 25, the first light-sensitive sensor array 26 and the second light-sensitive sensor array 27.

It seems that the scanning device 20 is able to overcome all the problems described above. However, for one skilled in the art, it is obvious that the technology and the means used in the published Japanese Patent Application No. 2004-126284 not only have a small application field but also bring out more problems.

Firstly, the relative position and the relative arrangement of the first rod lens 22 and the second rod lens 23 are limited by the corresponding first light-sensitive sensor 26 and second light-sensitive sensor 27, wherein the first light-sensitive sensor 26 and second light-sensitive sensor 27 are fixed in parallel. Consequently, the size of the scanning device 20 is limited. Since the microminiature device is desirous, the number of rod lens must be restricted to minimize the size of the scanning device. That is the reason, why the foresaid Japanese Patent Application could only be applied as a scanning device having two sets of rod lenses.

Secondly, since the scanning device 20 has only two sets of rod lenses and two sets of light-sensitive sensor arrays, the application field of the scanning device 20 is limited at certain levels. Namely, the focal lengths applied to scan different objects 28, 29 are not broad enough.

Further, the relative positions of the first light-sensitive sensor array 26 and the second light-sensitive sensor array 27, the relative position of the first rod lens 22 and the second rod lens 23 and the relative positions of two sets of light-sensitive sensor arrays 26 and 27, two sets of rod lenses 22 and 23 and the circuit board 25 are fixed. Although, the scanning device 20 in FIGS. 2(a)-2(c) has an additional scanning focal length and an additional scanning resolution being compared with the scanning module 10 in FIGS. 1(a)-1(c), the focal length and the resolution of the scanning device 20 are still not adjustable.

In order to overcome the foresaid problems, the present invention provides a scanning device with multifocus and multiresolution.

### SUMMARY

In one respect of the present invention, a scanning device with multifocus and multiresolution is provided.

The scanning device with multifocus and multiresolution includes a circuit board, at least two sets of light-sensitive sensor arrays having a first light-sensitive sensor array and a second light-sensitive sensor array, at least a set of rod lenses having a first rod lens and a second rod lens, and a first glass plate mounted above the set of rod lenses. The first light-sensitive sensor array and the second light-sensitive sensor array are aligned on the circuit board. The first rod lens and the second rod lens are respectively mounted above the first light-sensitive sensor array and the second light-sensitive sensor array. The multifocus and multiresolution are provided by the two sets of light-sensitive sensor arrays and the set of rod lenses for scanning different objects placed on the first glass plate.

Preferably, the contact image sensor (CIS) technology is used in the scanning device with multifocus and multiresolution.

Preferably, the scanning device with multifocus and multiresolution further includes a case for packing the circuit board, the two sets of light-sensitive sensor arrays, the set of rod lenses and the first glass plate.

Preferably, the first light-sensitive sensor array and the second light-sensitive sensor array are respectively formed by at least one first light-sensitive sensor and at least one second light-sensitive sensor.

Preferably, the thicknesses of the first light-sensitive sensor and the second light-sensitive sensor are ones of identical thicknesses and non-identical thicknesses.

Preferably, the thicknesses of the first light-sensitive sensor and the second light-sensitive sensor are selected according to a thickness of the first glass plate and a vertical distance between the first glass plate and the two sets of light-sensitive sensor arrays.

Preferably, the focal lengths of the first rod lens and the second rod lens are ones of identical focal lengths and non-identical focal lengths.

Preferably, the focal lengths of the first rod lens and the second rod lens are selected according to the thickness of the first glass plate, the thicknesses of the first light-sensitive sensor and the second light-sensitive sensor and the vertical distance between the first glass plate and the two sets of light-sensitive sensor arrays.

Preferably, the scanning device with multifocus and multiresolution further includes a second glass plate mounted at a position, which is one of a first position between the first rod lens and the first light-sensitive sensor array and a second position between the second rod lens and the second light-sensitive sensor array.

Preferably, the scanning device with multifocus and multiresolution further includes a spacer mounted at a position, which is one of a third position between said first light-sensitive sensor array and said circuit board and a fourth position between said second light-sensitive sensor array and said circuit board.

In another aspect of the present invention, the scanning device with multifocus and multiresolution includes at least two sets of light-sensitive sensor arrays having a first light-sensitive sensor array and a second light-sensitive sensor array, at least a set of rod lenses having a first rod lens and a second rod lens, a glass plate mounted above the set of rod lenses, at least a first circuit board and a second circuit board. The first light-sensitive sensor array and the second light-sensitive sensor array are arranged in a manner being one of an alignment and a parallel arrangement, and are respectively arranged on the first circuit board and the second circuit board. The first rod lens and the second rod lens are respectively mounted above the first light-sensitive sensor array and the second light-sensitive sensor array. The multifocus and multiresolution are formed by adjusting relative positions of the first circuit board and the second circuit board for scanning different objects placed on the glass plate.

Preferably, the contact image sensor (CIS) technology is used in the scanning device with multifocus and multiresolution.

Preferably, the scanning device with multifocus and multiresolution further includes a case for packing the first circuit board, the second circuit board, the two sets of light-sensitive sensor arrays, the set of rod lenses and the glass plate.

Preferably, the first circuit board and the second circuit board are connected by a connector.

Preferably, the first light-sensitive sensor array and the second light-sensitive sensor array are respectively formed by at least one first light-sensitive sensor and at least one second light-sensitive sensor.

Preferably, the thicknesses of the first light-sensitive sensor and the second light-sensitive sensor are ones of identical thicknesses and non-identical thicknesses.

Preferably, the thicknesses of the first light-sensitive sensor and the second light-sensitive sensor are selected according to a thickness of the glass plate and a vertical distance between the glass plate and the two sets of light-sensitive sensor arrays.

Preferably, the focal lengths of the first rod lens and the second rod lens are ones of identical focal lengths and non-identical focal lengths.

Preferably, the focal lengths of the first rod lens and the second rod lens are selected according to the thickness of the first glass plate, the thicknesses of the first light-sensitive sensor and the second light-sensitive sensor and the vertical distance between the glass plate and the two sets of light-sensitive sensor arrays.

In another aspect of the present invention, the scanning device with multifocus and multiresolution includes a circuit board, at least two sets of light-sensitive sensor arrays having a first light-sensitive sensor array and a second light-sensitive sensor array, at least a set of rod lenses having a first rod lens, a second rod lens, a glass plate mounted above the set of rod lenses and a plate mounted at a position being one of a first position between the first rod lens and the first light-sensitive sensor array and a second position between the second rod lens and the second light-sensitive sensor array. The first light-sensitive sensor array and the second light-sensitive sensor array are arranged in parallel on the circuit board. The first rod lens and the second rod lens are respectively mounted above the first light-sensitive sensor array and the second light-sensitive sensor. The multifocus and multiresolution are formed by the two sets of light-sensitive sensor arrays, the set of rod lenses and the plate for scanning different objects on the glass plate.

Preferably, the contact image sensor (CIS) technology is use in the scanning device with multifocus and multiresolution.

Preferably, the scanning device with multifocus and multiresolution further includes a case for packing the circuit board, the two sets of light-sensitive sensor arrays, the set of rod lenses, the glass plate and the plate.

Preferably, the first light-sensitive sensor array and the second light-sensitive sensor array are respectively formed by at least one first light-sensitive sensor and at least one second light-sensitive sensor.

Preferably, the thicknesses of the first light-sensitive sensor and the second light-sensitive sensor are ones of identical thicknesses and non-identical thicknesses.

Preferably, the thicknesses of the first light-sensitive sensor and the second light-sensitive sensor are selected according to the thicknesses of the glass plate and the plate and a vertical distance between the glass plate and the two sets of light-sensitive sensor arrays.

Preferably, the focal lengths of the first rod lens and the second rod lens are ones of identical focal lengths and non-identical focal lengths.

Preferably, the focal lengths of the first rod lens and the second rod lens are selected according to the thicknesses of the glass plate and the plate, the thicknesses of the first light-sensitive sensor and the second light-sensitive sensor and the vertical distance from the glass plate to the two sets of light-sensitive sensor arrays.

Preferably, the plate is made of one of a glass and a transparent resin material and the plate having a refractive index ranged from 1.3 to 1.7 has a selected thickness according to the refractive index, the focal lengths of the set of rod lens, the thicknesses of the first light-sensitive sensor and the second light-sensitive sensor.

Preferably, the plate is made of one selected from a group consisting of a PC, a PET, a PMMA, a COC, an MCOC, a TOPAS, an ARTON, a ZEONEX, an APEL, an OPET, a PET, a TPX, a PES.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1(a) is a cross-sectional view of a scanning module using CIS technology according to the prior art;

FIG. 1(b) is a cross-sectional view showing a relationship between a scanned object and a scanning module using CIS technology according to the prior art;

FIG. 1(c), is a cross-sectional view showing another relationship between an object and a scanning module using CIS technology sensor according to the prior art;

FIG. 2(a) is a schematic view showing a relationship between an object and the scanning device using CIS technology according to the published Japanese Patent Application No. 2004-126284.

FIG. 2(b) is a schematic view showing another relationship between an object and the scanning device using CIS technology according to the published Japanese Patent Application No. 2004-126284.

FIG. 3(a) is a schematic view of the scanning device with multifocus and multiresolution and using CIS technology according to the first preferred embodiment of the present invention;

FIG. 3(b)-3(e) are schematic views showing the relative positions of the first light-sensitive sensor array and the second light-sensitive sensor array shown in FIG. 3(a);

FIG. 4 is a schematic view of the scanning device with multifocus and multiresolution and using CIS technology according to the second preferred embodiment of the present invention;

FIG. 5 is a schematic view of the scanning device with multifocus and multiresolution and using CIS technology according to the third preferred embodiment of the present invention;

FIG. 6 is a schematic view of the scanning device with multifocus and multiresolution and using CIS technology according to the fourth preferred embodiment of the present invention;

FIG. 7 is a schematic view showing the relative position of the first light-sensitive sensor array and the second light-sensitive sensor array shown in FIG. 6;

FIG. 8 is a schematic view showing the relative position of the first light-sensitive sensor array and the second light-sensitive sensor array of a scanning device with multifocus and multiresolution and using CIS technology according to the fifth preferred embodiment of the present invention; and

FIG. 9 is schematic view of a scanning device with multifocus and multiresolution and using CIS technology according to the sixth preferred embodiment of the present invention.

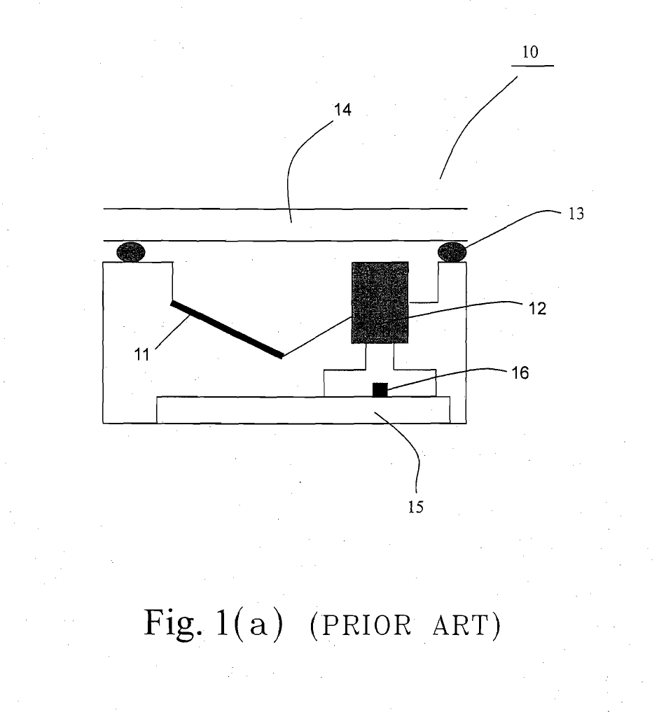

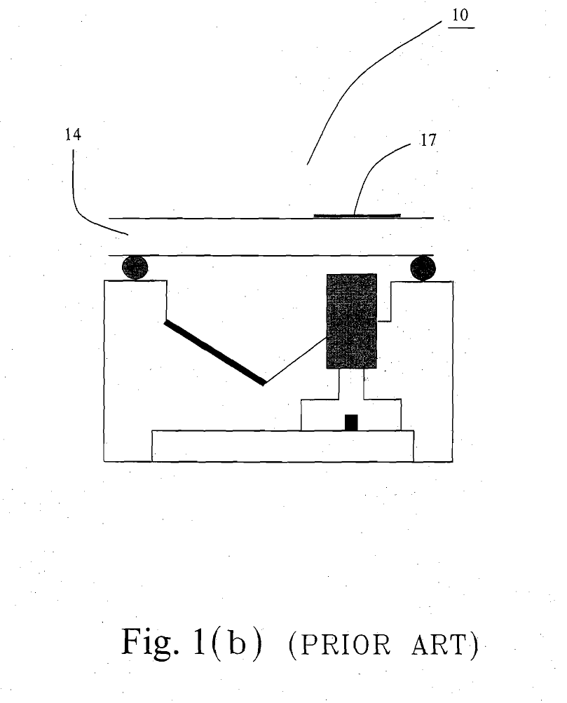

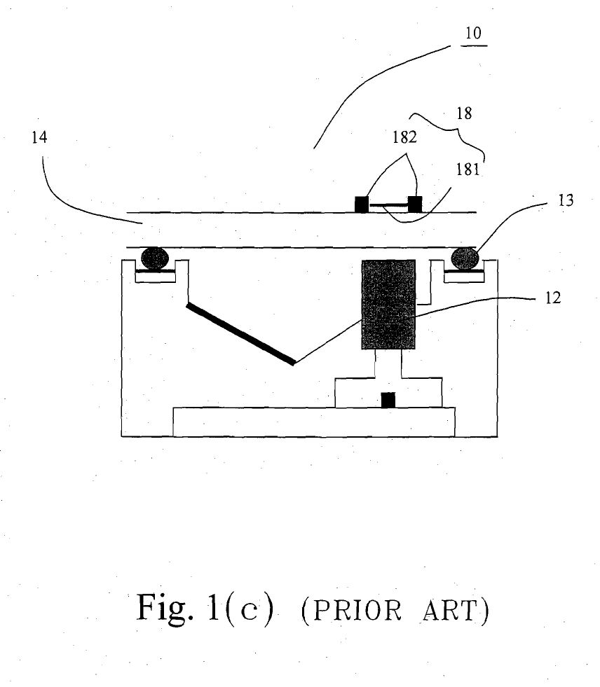

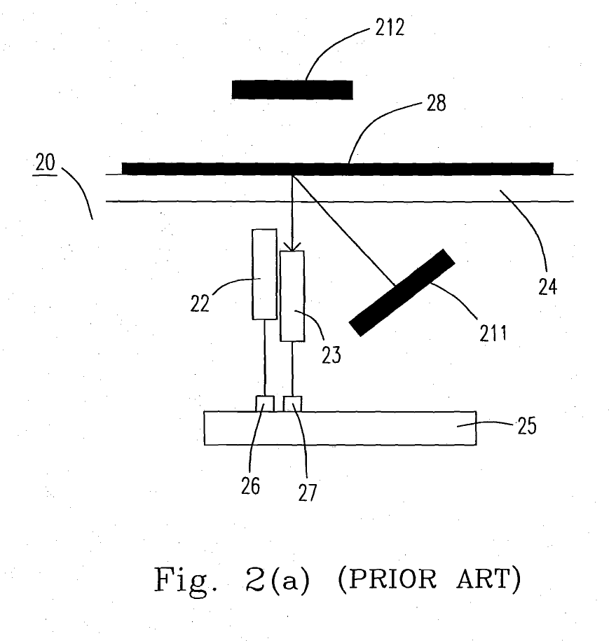

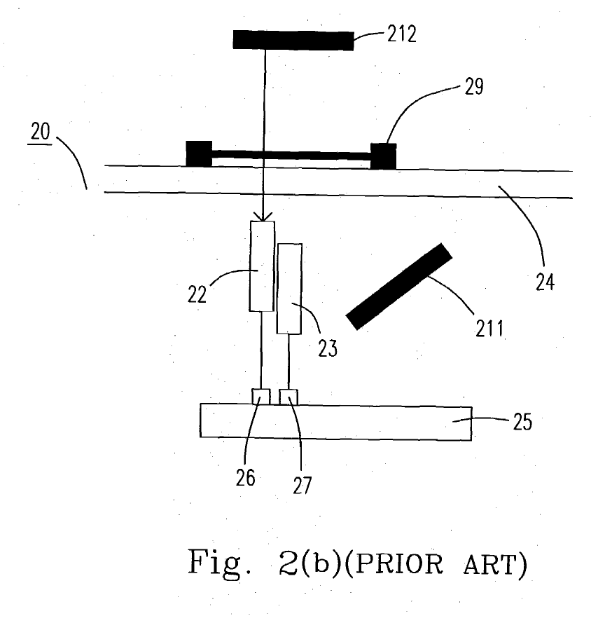

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

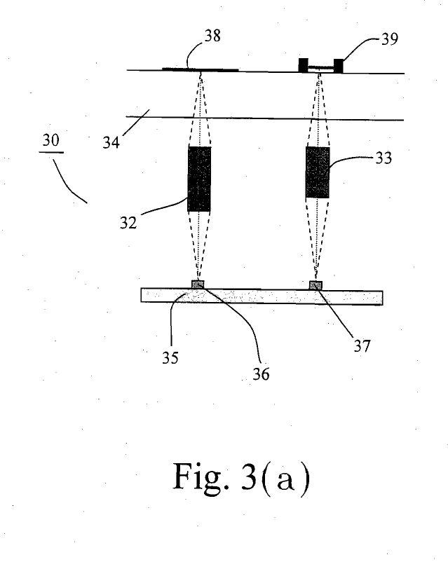

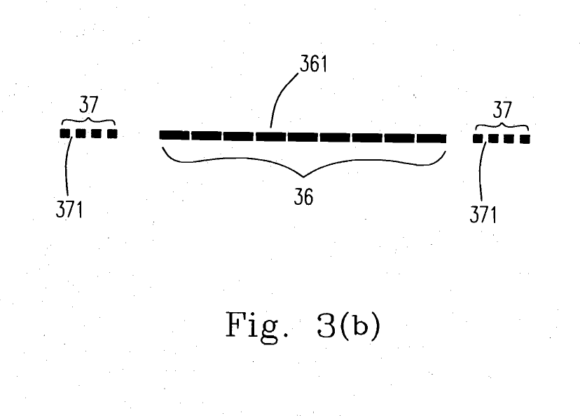

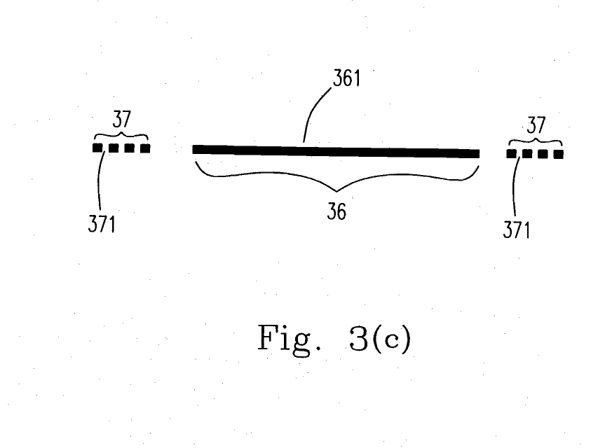

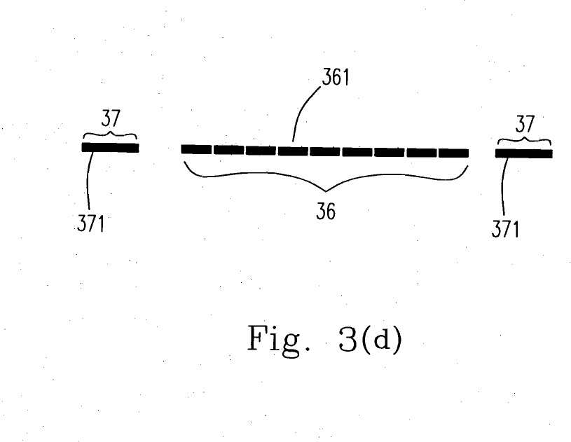

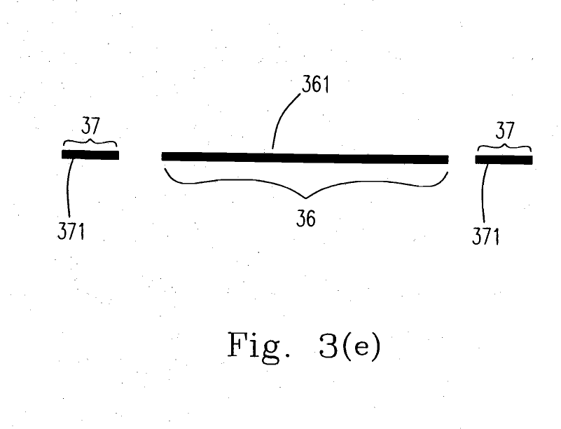

Please refer to FIG. 3(a), which is a schematic view showing a scanning device with multifocus and multiresolution and using CIS technology according to the first preferred embodiment of the present invention. CIS technology is applied to build the scanning device 30 and the scanning device 30 with multifocus and multiresolution is formed by packing the first rod lens 32, the second rod lens 33, the glass plate 34, the circuit board 35, the first light-sensitive sensor array 36 and the second light-sensitive sensor array 37 in a case (not shown).

As shown in FIG. 3(a), the first rod lens 32 and the second lens 33 are respectively mounted above the first light-sensitive sensor array 36 and the second light-sensitive sensor array 37. The glass plate 34 is mounted above the first rode lens 32 and the second rod lens 33. The first light-sensitive sensor array 36 and the second light-sensitive sensor array 37 are aligned on the circuit board 35, wherein the first light-sensitive sensor array 36 and the second light-sensitive sensor array 37 are respectively formed by at least one first light-sensitive sensor (not shown) and at least one second light-sensitive sensor (not shown).

Please further refer to FIGS. 3(b)-3(e), which are schematic views showing the relative positions of the first light-sensitive sensor array 36 and the second light-sensitive sensor array 37 shown in FIG. 3(a). As shown in FIGS. 3(a)-3(b), to satisfy with that the first light-sensitive sensor array 36 and the second light-sensitive sensor array 37 are aligned on the circuit board 35, a plurality of the second light-sensitive sensors 371 of the second light-sensitive sensor array 37 could aligned before or after a plurality of the first light-sensitive sensors 361 of the first light-sensitive sensor array 36. The first light-sensitive sensor array 36 and the second light-sensitive sensor array 37 are respectively formed by at least one first light-sensitive sensor (361) and at least one second light-sensitive sensor (371). Certainly, as shown in FIGS. 3(c)-3(e), the numbers and lengths of first light-sensitive sensor (361) and the second light-sensitive sensor are changeable.

Please refer to FIG. 3(a)-FIG. 3(e). According to the need, the thicknesses of the first light-sensitive sensors 361 and the second light-sensitive sensors 371 in FIGS. 3(b)-3(e) could be selected as the same or different for achieving the multifocus and multiresolution of the scanning functions of the scanning device 30. And the thicknesses of the first light-sensitive sensors 361 and the second light-sensitive sensors 371 in FIGS. 3(b)-3(e) are selected according to the thickness of the glass plate 34 and the vertical distance between the glass plate 34 and the two sets of light-sensitive sensor arrays (36, 37) in FIG. 3(a).

Similarly, the focal lengths of the first rod lens 32 and the second rod lens 33 in FIG. 3(a) could be same or different, and the focal lengths thereof are selected according to the thickness of the glass plate 34 and the vertical distance between the glass plate 34 and the two sets of light-sensitive sensor arrays (36, 37) in FIG. 3(a), the thicknesses of the first light-sensitive sensors 361 and the second light-sensitive sensors 371 in FIGS. 3(b)-3(e).

Please refer to FIG. 3(a), the combination of the first rod lens 32 and the first light-sensitive sensor array 36 is used for scanning the object 38, such as a paper or a document. In addition, the combination of the second rod lens 33 and the second light-sensitive sensor array 37 is used for scanning another object 39, which could be a film or an object requiring to be scanned with a high image resolution.

Namely, at least two foci and two resolutions are formed by the two sets of the light-sensitive sensor arrays 36, 37 and the rod lenses 32, 33 in the first embodiment for scanning the different objects placed on the glass plate. Further, although in the first embodiment is a bi-focus and bi-resolution scanning device, the technical design could be applied to provide a scanning device with multifocus and multiresolution by simply adding more light-sensitive sensor arrays and rod lenses.

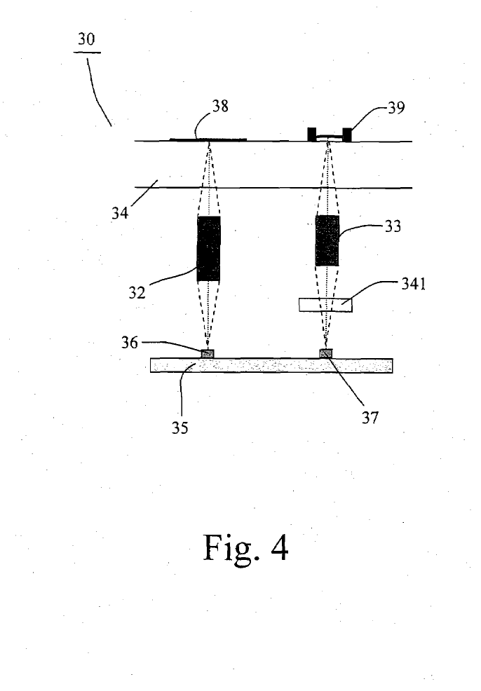

In addition, there is another way to achieve the multifocus and multiresolution of the scanning functions of the scanning device 30. Please refer to FIG. 4, which is a schematic view of the scanning device with multifocus and multiresolution and using CIS technology according to the second preferred embodiment of the present invention. As shown in FIG. 4, the second embodiment is similar to the first preferred embodiment shown in FIG. 3(a) except that a plate 341 is located between the first rod lens 32 and the first light-sensitive sensor array 36 (it should be noted that the glass plate 341 is also able to be located between the second rod lens 33 and the second light-sensitive sensor array 37). Certainly, the plate 341 could be made of one of a glass and a transparent resin material and the plate having a refractive index ranged from 1.3 to 1.7 has a selected thickness according to the refractive index, the focal lengths of the set of rod lenses 32 and 33, the thicknesses of the first light-sensitive sensors 36 and the second light-sensitive sensors 37. Or the plate could be made of one selected from a group consisting of a PC, a PET, a PMMA, a COC, an MCOC, a TOPAS, an ARTON, a ZEONEX, an APEL, an OPET, a PET, a TPX, a PES.

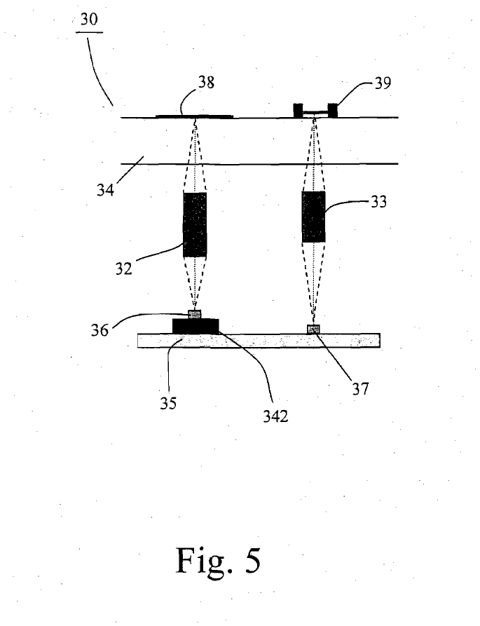

Similarly, there is still another way to achieve the multifocus and multiresolution of the scanning functions of the scanning device 30. Please refer to FIG. 5, which is a schematic view of the scanning device with multifocus and multiresolution and using CIS technology according to the third preferred embodiment of the present invention. As shown in FIG. 5, the third embodiment is similar to the first preferred embodiment shown in FIG. 3(a) except that a spacer 342 is set up between the circuit board 35 and the first light-sensitive sensor array 36 (it should be noted that the spacer 342 is also able to be located between the circuit board 35 and the second light-sensitive sensor array 37). Similarly, by changing the thickness or the position of the spacer 342, the multifocus and multiresolution of the scanning device 30 could be performed.

Being compared with the prior art, at least two foci and two resolutions are formed by a plurality of sets of the light-sensitive sensor arrays and a plurality of set of rod lenses in the foresaid preferred embodiment. Therefore, the scanning device could be used for scanning objects requiring different focal lengths. Furthermore, the arrangements of the first light-sensitive sensor array 36 and the second light-sensitive sensor array 37 not only accommodate to the requirements of different technical designs but also are able to reduce the whole size of the scanning device for satisfying the microminiature aim.

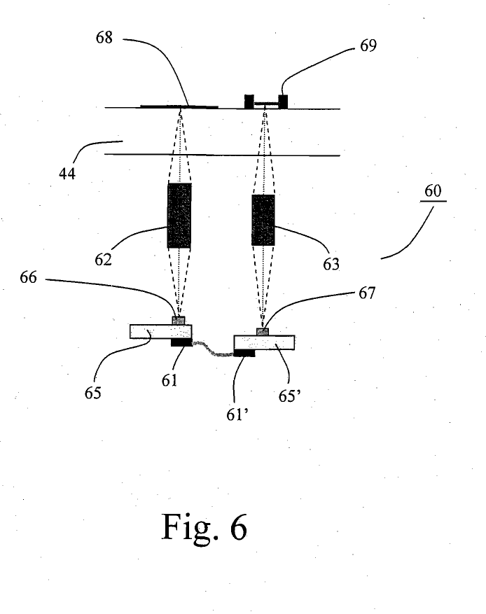

Please refer to FIG. 6, which is a schematic view showing a scanning device with multifocus and multiresolution and using CIS technology according to the fourth preferred embodiment of the present invention. The fourth preferred embodiment of the present invention is different from the first preferred embodiment of the present invention, because the first light-sensitive sensor array 66 and the second light-sensitive sensor array 67 are respectively on the first circuit board 65 and the second circuit board 65′, and the first circuit board 65 and the second circuit board 65′ are connected by the connectors 61 and 61′.

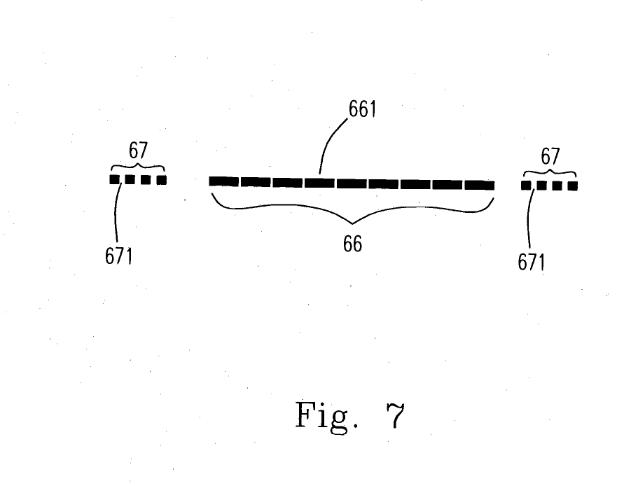

Please refer to FIG. 6 and FIG. 7 simultaneously, a plurality of the second light-sensitive sensors 671 of the second light-sensitive sensor array 67 could be aligned before or after. a plurality of the first light-sensitive sensors 661 of the first light-sensitive sensor array 66 to satisfy with that the first light-sensitive sensor array 66 and the second light-sensitive sensor array 67 are respectively aligned on the first circuit board 65 and the second circuit board 65′ in the fourth preferred embodiment.

Besides the controlling factors that are described in the first preferred embodiment, which are the thicknesses of the first light-sensitive sensors and the second light-sensitive sensors, the thickness of glass plate and the vertical distance between the glass plate and the two sets of the light-sensitive sensor arrays, the fourth preferred embodiment in FIG. 6 has another controlling factor, which is the relative position of the first circuit board 65 and the second circuit board 65′. All theses controlling factors are used for more sensitively controlling the scanning functions of the scanning device with multifocus and multiresolution.

The fourth preferred embodiment is similar to the first preferred embodiment shown in FIG. 3(a). The combination of the first rod lens 62 and the first light-sensitive sensor array 66 is used for scanning the scanned object 68, such as a paper or a document. In addition, combination of the second rod lens 63 and the second light-sensitive sensor array 67 are used for scanning the object 69, which could be a film or an object requiring to be scanned with a high image resolution. Furthermore, the technical design could be applied to provide a scanning device with multifocus and multiresolution by simply adding more circuit boards, more sets of the light-sensitive sensor arrays and more sets of rod lenses.

Being compared with the prior art, the fourth preferred embodiment on the basis of the combination of a plurality of sets of the light-sensitive sensor arrays and a plurality of sets of rod lenses has an additional controlling factor, that is the relative position of the circuit boards, for scanning objects requiring different focal lengths.

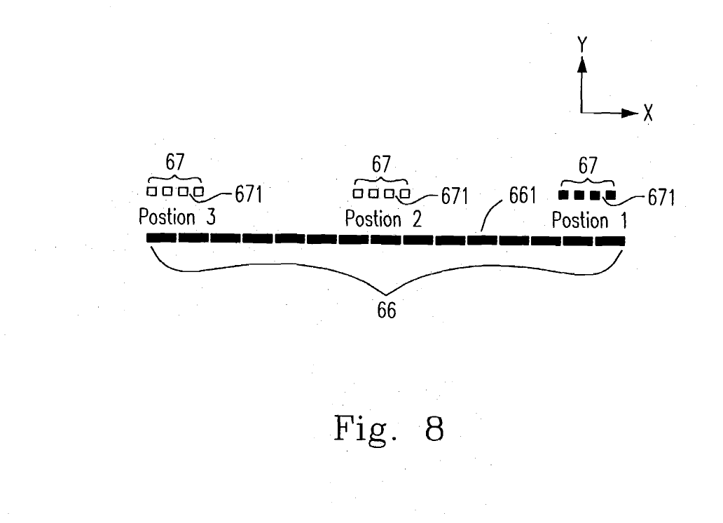

The structure of the fifth preferred embodiment of the present invention is similar to that of the fourth preferred embodiment, as shown in FIG. 5. In which, the first light-sensitive sensor array 66 and the second light-sensitive sensor array 67 are respectively arranged on the first circuit board 65 and the second circuit board 65′ in both embodiments. The only distinction therebetween is the relative arrangement of the sensors. Please refer to FIG. 8, which is a schematic view showing the relative position of the first light-sensitive sensor array and the second light-sensitive sensor array of a scanning device according to the fifth preferred embodiment of the present invention. As shown in FIG. 8, the first light-sensitive sensors 661 and the second light-sensitive sensors 671 of two sets of the light-sensitive sensor arrays (66, 67) are arranged in parallel.

As shown in FIG. 8, in addition, the length of the second light-sensitive sensor array 67 could be formed according to the requirement of the object, and the positions of the second light-sensitive sensor array 67 along the X-axis could also be determined according to the designer's desire, such as one selected from the position 1, position 2 or position 3. Furthermore, the positions of the second light-sensitive sensor array 67 along the Y-axis could be adjusted for the convenience of production.

Being compared with the prior art, the fifth preferred embodiment has at least two foci and two resolutions formed by the combination of a plurality of sets of the light-sensitive sensor arrays and a plurality of sets of rod lenses. Besides, the arrangements of the light-sensitive sensor arrays become more variable. Furthermore, after modulating the relative positions of a plurality of circuit boards, the scanning device would have the selectiveness and matching-ability to various objects to be scanned.

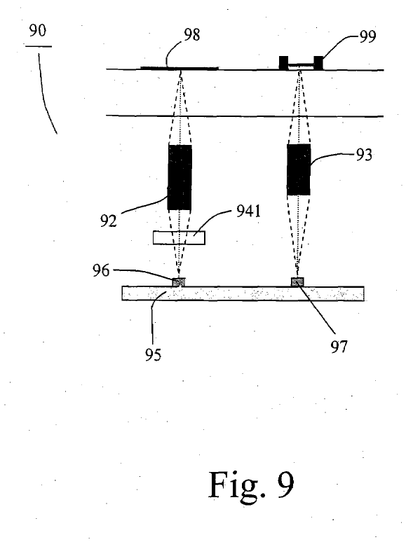

Please refer to FIG. 9, which is a schematic view showing a scanning device with multifocus and multiresolution according to the sixth preferred embodiment of the present invention. The plate 941 is located between the first rod lens 92 and the first light-sensitive sensor array 96 (it should be noted that the plate 941 is also able to be located between the second rod lens 93 and the second light-sensitive sensor array 97). By changing the thickness of the plate 941, the multifocus and multiresolution of the scanning device 90 could be performed. Although the sixth preferred embodiment is similar to that another plate 941 is used in the second preferred embodiment and the first light-sensitive sensor array 96 and the second light-sensitive sensor array 97 are arranged on the same circuit board 95, the two sets of light-sensitive sensor arrays are arranged in parallel as shown in FIG. 9.

Being compared with the prior art, the sixth preferred embodiment further includes a controlling factor of the thickness of the plate 941 and the selectiveness of the multifocus and multiresolution are more variable. Therefore, the scanning device regarding to various objects, such as object 98 and 99, could have more flexibility.

The present scanning device has at least two foci and two resolutions by cooperating the following factors. First, the combination of a plurality of circuit boards, a plurality of light-sensitive sensor arrays and a plurality of rod lenses are changeable. Second, the relative positions of the circuit boards and the relative positions of the light-sensitive sensor arrays could be easily adjusted. Third, the thicknesses of the light-sensitive sensors, the vertical distance between the glass plate and the light-sensitive sensor array, and the thickness and the length of the glass plate are selectable.

Since +/−0.025 mm, +/−0.05 mm and +/−0.025 mm are respectively the tolerance of a plastic ball, a steal ball and a slide, and the problems of deformation or abrasion, the technical design of using a height adjustable spacer described in the prior art has a height adjustment tolerance over +/−0.1 mm. Therefore, the existence of the tolerance will seriously affect the value of the modulation transfer function. However, the scanning device in the present invention wouldn't suffer the problems of having a tolerance, and will have better scanning quality.

The present invention provides a scanning device using CIS technology for scanning various objects. In addition, the present invention is not only tied in different design requirements but also reduces the size of the scanning device for satisfying the microminiature tide. Furthermore, the present invention could be used on the multifunction printer (MFP).

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A scanning device with multifocus and multiresolution, comprising:
at least a first circuit board and a second circuit board;
at least two sets of light-sensitive sensor arrays having a first light-sensitive sensor array, and a second light-sensitive sensor array, wherein said first light-sensitive sensor array and said second light-sensitive sensor array are arranged in a manner being one of an alignment and a parallel arrangement, and respectively arranged on said first circuit board and said second circuit board;
at least a set of rod lenses having a first rod lens and a second rod lens, wherein said first rod lens and said second rod lens are respectively mounted above said first light-sensitive sensor array and said second light-sensitive sensor array; and
a glass plate mounted above said set of rod lenses;
wherein said multifocus and multiresolution are formed by adjusting relative positions of said first circuit board and said second circuit board for scanning different objects placed on said glass plate.

2. The scanning device with multifocus and multiresolution as claimed in claim 1 using a contact image sensor (CIS) technology.

3. The scanning device with multifocus and multiresolution as claimed in claim 1, further comprising a case for packing said first circuit board, said second circuit board, said two sets of light-sensitive sensor arrays, said set of rod lenses and said glass plate.

4. The scanning device with multifocus and multiresolution as claimed in claim 1, wherein said first circuit board and said second circuit board are connected by a connector.

5. The scanning device with multifocus and multiresolution as claimed in claim 1, wherein said first light-sensitive sensor array and said second light-sensitive sensor array are respectively formed by at least one first light-sensitive sensor and at least one second light-sensitive sensor.

6. The scanning device with multifocus and multiresolution as claimed in claim 4, wherein thicknesses of said first light-sensitive sensor and said second light-sensitive sensor are ones of identical thicknesses and non-identical thicknesses.

7. The scanning device with multifocus and multiresolution as claimed in claim 4, wherein said thicknesses of said first light-sensitive sensor and said second light-sensitive sensor are selected according to a thickness of said glass plate and a vertical distance between said glass plate and said two sets of light-sensitive sensor arrays.

8. The scanning. device with multifocus and multiresolution as claimed in claim 1, wherein focal lengths of said first rod lens and said second rod lens are ones of identical focal lengths and non-identical focal lengths.

9. The scanning device with multifocus and multiresolution as claimed in claim 1, wherein said focal lengths of said first rod lens and said second rod lens are selected according to said thickness of said first glass plate, said thicknesses of said first light-sensitive sensor and said second light-sensitive sensor and said vertical distance between said glass plate and said two sets of light-sensitive sensor arrays.
